(19) United States
(12) Patent Application Publication
(10) Pub. No.: US 2021/0031425 A1
(43) Pub. Date: Feb. 4, 2021

(54) PRESSURE SENSOR

(71) Applicant: KISTLER HOLDING AG, WINTERTHUR (CH)

(72) Inventor: TANJA HATT, WINTERTHUR (CH)

(21) Appl. No.: 16/964,487

(22) PCT Filed: Jan. 24, 2019
(86) PCT No.: PCT/EP2019/051796

§ 371 Date: Jul. 23, 2020

(30) Foreign Application Priority Data
Feb. 13, 2018 (EP) 18156507.8

(51) Int. Cl. B29C 45/77

(52) U.S. Cl. CPC B29C 45/77; B29C 2045/2722; B29C 2945/76006

(57) ABSTRACT

A pressure sensor suitable for installation in a shaping part, such as an injection mold, from a pressure measurement side thereof is defined by a dimension measured perpendicular to its longitudinal axis at the measurement end that is greater than or equal to all other dimensions measured perpendicular to the longitudinal axis along the longitudinal axis of the sensor. A method for installing the pressure sensor in a shaping part is also disclosed.

### CROSS-REFERENCE TO RELATED APPLICATIONS

This application is a continuation of copending International Application No. PCT/EP2019/051796, filed Jan. 24, 2019, which is hereby incorporated herein by this reference in its entirety for all purposes.

### FIELD OF THE INVENTION

The invention relates to a pressure sensor to be installed in a shaping part such as for example in an injection mold. The pressure sensor defines a measurement end where the pressure to be measured is detected, and a longitudinal axis. Furthermore, the invention relates to an injection mold comprising a pressure sensor according to the invention. In addition, the invention relates to a method for installing a pressure sensor according to the invention in a shaping part such as for example in an injection mold.

### BACKGROUND OF THE INVENTION

Inner pressure sensors are known and widely used. They are used for measuring the pressure within an injection mold, for example, to improve the quality of the injection molded parts and, thus, also the process efficiency of injection molding. In general, the injection mold is a metallic multi-component injection mold that is installed in the injection molding machine. The injection mold comprises a base plate and a shaping part. The shaping part is removable and exchangeable. During operation of the injection mold the base plate and shaping part are rigidly connected to one another.

Conventional cavity pressure sensors are installed from the rear side, that is from the base plate side. Typically, the cavity pressure sensor is attached either by a screw nipple (for example type 6457 assembly nipple by the applicant) or by a spacer sleeve (for example type 1720A by the applicant). In this way, the sensor output signal which may be a charge, for example, is either fed directly into a cable (single-wire or coaxial cable) attached to the sensor or is fed via a charge-conducting spacer sleeve followed by a contact member into a cable that is installed only in the base plate so that no cable is present in the mold insert. Such sensor arrangement has the advantage that it is possible to use pressure sensors having small dimensions in the area of the sensor front face (the area of pressure detection), i.e. on the inner side of a mold insert, so that pressure measurements may be performed even in the case of small mold inserts. In addition, the sensor front face may be designed to create no visible impression of the sensor front in the injection molded part. The pressure sensor is secured to the mold insert on the outside thereof or in or via the base plate, respectively, so that the dimensions of the screw nipple, spacer sleeve and/or contact member measured in the radial direction are larger than those of the sensor front. Moreover, a sensor rear face (the end of the cavity pressure sensor opposite of the sensor front face) that is wider than the sensor front face will be required if a signal cable is connected to the sensor via a connector or if such a signal cable leads away directly from the rear face of the sensor.

For example, CH573592A5, which corresponds to applicant's U.S. Pat. No. 4,059,999, which is hereby incorporated herein by this reference for all purposes, discloses a transducer for measuring the pressure evolution during the injection process of plastic compounds. The transducer enables a process computer to continuously determine the most favorable refill amount for each workpiece whereby continuous operation is possible without any supervision by trained control personnel. To get information about the pressure distribution at critical positions of the workpiece, the pressure sensor is installed directly in the injection and press mold. The pressure transducer is clamped into the injection and press mold from the outside thereof by means of an assembly screw where a stop surface of the pressure transducer is supported on a corresponding shoulder in the injection and press mold to prevent it from being pushed into the cavity of the injection and press mold.

A disadvantage of such assemblies is that manufacturing a bore in the shaping part for receiving the cavity pressure sensor is very complex. Due to the dimensional profile of the cavity pressure sensor described above the bore must be made from the outside of the injection mold and the accuracy of fit of the bore becomes increasingly poor with increasing bore depth due to deviation of the drill path and, consequently, the accuracy of fit of the bore is worst on the inner side of the shaping part. However, this is exactly where it should be best for a reliable pressure measurement because this is where the measurement end (sensor front face) is located. If the accuracy of fit is inadequate in the area of the sensor front face the pressure sensor will either get stuck in the bore or injection molding compound will penetrate into a space between the bore wall and the measurement end both preventing a reliable pressure measurement.

### OBJECTS AND SUMMARY OF THE INVENTION

It is an object of the present invention to provide a pressure sensor belonging to the technical field mentioned in the beginning suitable for being installed in a recess (such as a bore) in a shaping part (such as an injection mold) wherein the required accuracy of fit of the recess is easier to achieve than for those of the prior art. Furthermore, it is an object of the present invention to provide a method which simplifies the installation of a pressure sensor according to the invention in a shaping part, in particular in an injection mold, as compared to the prior art.

This object has been achieved as defined by the features described below.

According to the invention, the pressure sensor is suitable for being installed in a shaping part and can be installed from a pressure measurement side of the shaping part. The pressure sensor comprises a measurement end where the pressure to be measured is detected, and a longitudinal axis. The pressure sensor is characterized in that a dimension measured perpendicular to the longitudinal axis at the measurement end is greater than or equal to all other dimensions measured perpendicular to the longitudinal axis along the longitudinal axis and in that the pressure sensor comprises a contact for contacting a contact member.

The pressure sensor according to the invention can be installed from the pressure measurement side of the shaping part so that the recess in the shaping part intended to receive the pressure sensor can be manufactured from the pressure measurement side. Such a recess can be manufactured much more precisely compared to a recess that must be prepared from the side opposite of the pressure measurement side of the shaping part. In other words, the required accuracy of fit of the recess is easier to achieve when the recess is manufactured from the pressure measurement side compared to a recess that is manufactured from the side opposite of the pressure measurement side.

A shaping part is intended to mean an object which may partially enclose a cavity in which a pressure is to be measured. A shaping part may be an injection mold or a part thereof such as for example a mold insert. Further examples of shaping parts include an engine block having one or more cylinder bores in which a pressure is to be measured, or a rim that together with a tire encloses a cavity in which a pressure is to be measured. In theory, also the tire could represent a shaping part. Advantageously, the shaping part may be made of metal, metal compounds and/or materials with comparable temperature resistance and strength such as for example composite materials.

The pressure measurement side of the shaping part is that side of the shaping part on which the pressure is to be measured during operation. This side is also called the inner side.

In the following, the side of the shaping part opposite of the pressure measurement side and which is not exposed to the pressure to be measured even in operation will be referred to as the outer side.

The measurement end of the pressure sensor is the end that is exposed to the pressure to be measured during operation. This is also where the sensor front face is located. In the following, the end of the pressure sensor opposite to the measurement end will be referred to as the contact end because this is usually where a contact for contacting a contact member or a cable for picking up and/or transferring the sensor measurement signal can be connected.

The recess in the shaping part fabricated from the pressure measurement side of the shaping part has a constant cross-section or a cross-section that tapers with increasing depth for the pressure sensor according to the invention to be accommodated snugly within the recess. Accordingly, the pressure sensor according to the invention has a constant or tapering cross-section in the longitudinal direction from the measurement end, i.e. it may for example have a cross-section along the longitudinal axis that is at least partially constant, stepped and/or continuously (or otherwise) tapering in the direction towards the contact end.

In an advantageous embodiment, the pressure sensor according to the invention is suitable for being installed in an injection mold from an inner side of the injection mold.

As already mentioned, an injection mold is a special case of the shaping part and other designs of the shaping part are also possible.

An advantage of the pressure sensor of the invention according to the present embodiment is that the pressure sensor may be removed much more readily in the case of fault finding or damage since it is not necessary to completely disassemble the injection mold or the mold insert thereof.

In another advantageous embodiment the pressure sensor according to the invention at least partially has a circular cross section.

Such sensors are particularly easy to manufacture and, furthermore, it is particularly easy to insert them in a corresponding bore, for example by a turning movement.

Alternatively and/or additionally, the cross section may also be of any other shape such as angular.

In a particular embodiment, the pressure sensor according to the invention comprises a securing means.

In this way, the pressure sensor may be secured in the shaping part and, in particular, in an injection mold. In the case of a multi-component injection mold, the pressure sensor may be secured by means of the securing means either in the mold insert or in the base plate.

The securing means may for example introduce a force into the pressure sensor by which it is pressed into the recess in the shaping part, i.e. from the pressure measurement side of the shaping part towards the outer side of the shaping part. This force has the same direction as the force generated by the pressure to be measured and also acting upon the pressure sensor. Therefore, the pressure sensor may be designed such that the force originating from a securing means acts in the same direction as the force generated by the pressure to be measured. This has the advantage that the securing means must only be configured for small forces, for example the gravitational force of the pressure sensor, to prevent the pressure sensor from falling out of the recess. Furthermore, in operation the pressure sensor is also pressed into the recess by the force generated by the pressure to be measured so that it is substantially prevented from falling out. This is a significant difference compared to conventional pressure sensors which are secured in the shaping part from its outer side whereby a force acts on them from the securing means that is directed from the outer side of the shaping part towards the inner side, i.e. towards the pressure measurement side, and opposed to the force generated by the pressure to be measured. Therefore, the securing means of such conventional sensors must not only withstand the gravitational force of the pressure sensor but also the force generated by the pressure to be measured. The pressure to be measured may be in the range of several thousand bars leading to considerable forces and thus complex securing means are required in the case of conventional pressure sensors.

In a particular embodiment, the securing means may be a securing means that is removable in the direction of the measurement end. This has the advantage that the removable securing means may be removed prior to installation of the pressure sensor and, thus, the pressure sensor core, i.e. the pressure sensor without the removable securing means, may have a dimension as measured perpendicular to the longitudinal axis at the measurement end that is smaller than any other dimension measured perpendicular to the longitudinal axis which is not at the measurement end. Inserting the pressure sensor core into the recess in the shaping part may be easier than inserting the complete pressure sensor. Afterwards, the removable securing means may be introduced into the space between an inner wall of the recess and the pressure sensor core. For example, the removable securing means may be pressed into the recess and the pressure sensor thus formed may be secured firmly in the recess. The removable securing means may exert a force upon a shoulder of the pressure sensor core, for example, so that the pressure sensor is pressed into the recess in the shaping part. In this case, the removable securing means may be a sleeve, for example.

Alternatively and/or additionally to using a securing means the sensor may also be pressed into the recess, for example.

In a further particular embodiment, the pressure sensor according to the invention at least partially comprises a thread.

By this it is for example possible to screw the pressure sensor into the shaping part from the pressure measurement side or to bolt it by means a bolt, banjo bolt, nut or nipple from the outer side of the shaping part.

The thread may be an internal thread or an external thread. An external thread may be preferably be arranged in a central region and/or in the region of the contact end of the pressure sensor. Alternatively and/or additionally, an internal thread may also be arranged in the area of the contact end.

In addition to the thread, the pressure sensor may comprise a form-locking element suitable for engaging a tool for tightening or unscrewing the pressure sensor in the area of the measurement end or in the area of the contact end. The form-locking element may have the form of a groove which can be engaged by a screwdriver. The form-locking element may also have the form of a polygon which can be engaged by an Allen key or a spanner.

In case the form-locking element is arranged at the measurement end, such as for example on the sensor front face, it may be covered with a cover so that no marks are left on an injection molded part when the pressure sensor is used in an injection mold. The cover may be in the form of a cap which may be secured firmly in the recess in the injection mold, for example by a clip mechanism, so that it does not fall out during normal operation. When the sensor is to be removed or for testing purposes, the cap or cover might be destroyed, if necessary, and replaced by a new one. The cap is pressure-transmitting.

In case of a securing means that is removable in the direction of the measurement end, this may comprise an external thread so that it may be screwed in a corresponding internal thread in the shaping part. In this case, the removable securing means may be for example a screw nipple.

Alternatively and/or in addition to the thread, the pressure sensor may also be secured or fastened to the shaping part by other securing means, such as by a bayonet lock or as explained below.

In another embodiment, the pressure sensor according to the invention is configured to produce a snap-fit connection with a respective counterpart.

This counterpart may be arranged in the shaping part so that the pressure sensor may be attached to the shaping part by means of a snap-fit connection.

The pressure sensor may for example comprise a bulge and/or projection in the radial direction where the bulge and/or projection are designed to form a snap-fit connection with the shaping part and in particular a snap-fit connection with an injection mold. The pressure sensor may also comprise a spring and/or elastic element for forming a snap-fit connection with the shaping part. In case of a multi-component injection mold the pressure sensor may form a snap-fit connection either in the mold insert or with the base plate.

In a further advantageous embodiment, the pressure sensor according to the invention comprises a notch for receiving a securing element.

This makes it again possible to attach and/or secure the pressure sensor in the shaping part and in particular in an injection mold. In case of a multi-component injection mold the pressure sensor may be attached and/or secured by means of the securing element either in the mold insert or the base plate.

The securing element may be for example a securing pin, a split pin or a securing ring.

In a preferred embodiment, the pressure sensor according to the invention comprises a moldable mark on a sensor front face.

This serves to deliberately apply marks, for example to an injection molded part.

The moldable mark may for example include alpha-numeric characters, in particular a date, a serial number and/or batch number. The moldable mark may be mirror-inverted so that the date, serial number and/or batch number are visibly displayed on the injection mold. The moldable mark may also include a groove or an arrow. For further details reference is made to the applicant's European patent application No. 17196594.0 of Oct. 16, 2017, which corresponds to applicant's US Patent Application Publication No. 2019-111604, which is hereby incorporated herein by this reference for all purposes.

In particular, the moldable mark may be combined with a form-locking element on the sensor front face which is suitable for engaging a tool for screwing in the pressure sensor.

Alternatively to the moldable mark, the sensor front face may be flat or have a shape that does not leave any marks on an injection molded part, for example.

In a further preferred embodiment, the pressure sensor according to the invention comprises an integrated temperature sensor.

This makes it possible to concurrently measure the pressure and temperature, which is particularly advantageous when the pressure sensor is used in an injection mold.

Another aspect of the present invention relates to an injection mold comprising a pressure sensor according to the invention.

Such an injection mold is manufactured, maintained and repaired more easily than an injection mold comprising a conventional pressure sensor.

In an advantageous embodiment, the injection mold according to the invention comprises a contact member.

An assembly of this type is very convenient in the case of an injection mold consisting of a base plate and a mold insert. In this case the pressure sensor may be arranged in the mold insert in a cableless manner, and the contact member may be arranged in the base plate.

Another aspect of the invention relates to a method for installing a pressure sensor according to the invention in a shaping part where said installing is performed from a pressure measurement side of the shaping part. The process includes the following steps of:
a) creating a recess in the shaping part from the pressure measurement side,
b) inserting the pressure sensor into the recess in the shaping part from the pressure measurement side of the shaping part, and
c) securing the pressure sensor in the shaping part or in a base plate that may be connected to the shaping part.

This method has the advantage that the recess in the shaping part may be produced more easily and more precisely and the pressure sensor may be installed more easily and quickly, in particular when retrofitted in the shaping part.

The recess may be formed in such a way that it tapers with increasing depth in the shaping part. This tapering in the recess may serve as a stop for the pressure sensor not to be pushed or pressed completely through the recess in the shaping part so that the pressure sensor is prevented from falling out on the outer side of the shaping part.

Securing of the pressure sensor in the shaping part may be done in a known manner.

In an advantageous embodiment of the method according to the invention the shaping part is an injection mold or a portion thereof, and the pressure measurement side of the shaping part is a cavity of the injection mold.

This has the advantage that it is not necessary to completely remove the injection mold from the injection molding machine for installing the pressure sensor.

In another advantageous embodiment of the method according to the invention, the recess is a bore or at least partially comprises a bore.

A bore can be manufactured particularly easily. Furthermore, a circular pressure sensor is particularly easy to insert in a circular recess by a turning movement and the risk of tilting is much lower than with angular recesses.

However, a recess consisting only partially of a bore and comprising additional geometric shapes, such as one or more longitudinal slots, may also be advantageous, for example for forming a bayonet mount.

A bore may have various diameters. For this purpose, the bore in the shaping part may be manufactured such that the diameter of the hole decreases with increasing depth, for example in a step-wise manner. However, a bore that is at least partially conical in shape may also be conceived. The aforementioned designs of the bore ensure that the pressure sensor may be supported on the shaping part. Therefore, the pressure sensor may also be at least partially conical in shape.

In another advantageous embodiment of the method according to the invention the securing step is selected from: screwing in, snapping in, and/or inserting a securing element.

In this way, the pressure sensor can be particularly easily attached and/or secured in the shaping part.

However, it is also possible to press the pressure sensor into the recess of the shaping part or to clamp the pressure sensor in the recess, for example, when a clamping device is provided in the pressure sensor or in the shaping part.

### BRIEF DESCRIPTION OF THE DRAWINGS

The drawings used to illustrate the exemplary embodiments show:

FIG. 1 a cross-sectional view of an embodiment of the pressure sensor provided with a thread and form-locking element in the area of the measurement end of the pressure sensor

FIG. 2 a cross-sectional view of an embodiment of the pressure sensor provided with a thread and form-locking element in the area of the contact end of the pressure sensor,

FIG. 3 a cross-sectional view of an embodiment of the pressure sensor with a securing element shown in an elevation view at the top of FIG. 3,

FIG. 4 a cross-sectional view of an embodiment of the pressure sensor with a snap-fit connection,

FIG. 5 a cross-sectional view of an embodiment of the pressure sensor with a spacer sleeve,

FIG. 6 an exploded view of the embodiment of FIG. 1,

FIG. 7 an exploded view of the embodiment of FIG. 2,

FIG. 8 an exploded view of the embodiment of FIG. 3,

FIG. 9 an exploded view of the embodiment of FIG. 4, and

FIG. 10 an exploded view of the embodiment of FIG. 5,

FIG. 11 a schematic representation of an assembly of a pressure sensor connected to an evaluation element.

Like parts are always designated by the same reference numerals throughout the Figures.

### DETAILED DESCRIPTIONS OF EXEMPLARY EMBODIMENTS

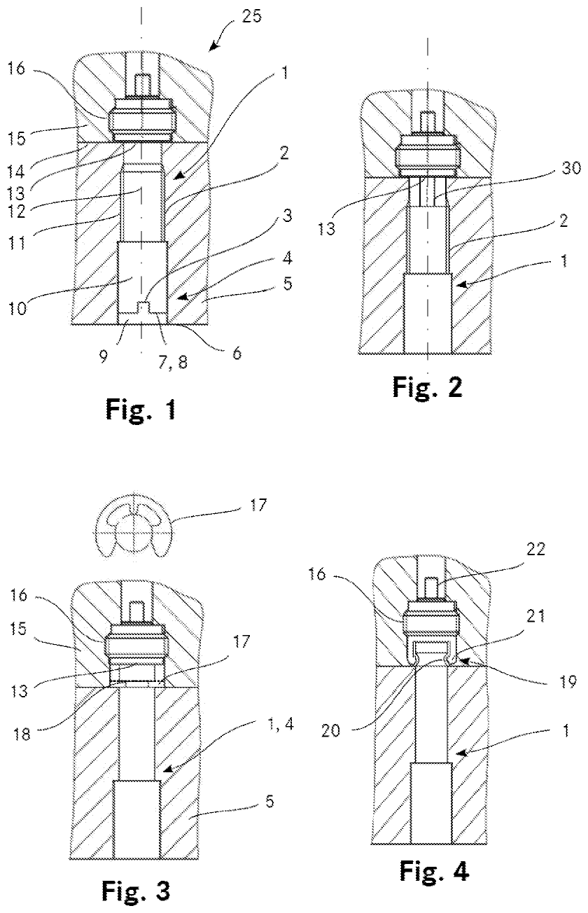

FIG. 1 shows an embodiment of the pressure sensor 1 generally indicated therein by the numeral 1 and comprising a thread 2 and a form-locking element 3. The dimensions of the pressure sensor 1 are such that it can be installed in a recess 4 of a shaping part 5 virtually without any play. The pressure sensor 1 defines at one axially opposite end thereof a measurement end 7 on which is defined a sensor front face 8 of the pressure sensor 1, both being also located on the pressure measurement side 6 of the shaping part 5. In this exemplary embodiment, the form-locking element 3 is located at the measurement end 7, in particular on the sensor front face 8. The form-locking element 3 is shaped as a groove so that for example a screwdriver may engage the form-locking element 3 for screwing the pressure sensor 1 into the recess 4 according to the thread 2. A cover 9 may be positioned on the sensor front face 8 after the pressure sensor 1 has been screwed into the recess 4 so that the pressure measurement side 6 is smooth and even also in the area of the recess 4 and the pressure sensor 1, respectively. Advantageously, the pressure sensor 1 includes a pressure transducer 10 that is disposed in the region of the pressure measurement end 7 of the pressure sensor 1. A thread 11 is formed in the recess 4 so that the pressure sensor can be screwed into the recess 4. In this exemplary embodiment, the recess 4 is a stepped bore having a larger diameter in the region of the measurement end 7 and/or in the region of the pressure transducer 10 than in the region of the thread 11 of the shaping part 5. The bore is symmetrical about a longitudinal axis 12 of the pressure sensor 1. The pressure sensor 1 defines a contact end 13, which is disposed axially opposite the measurement end 7 along the longitudinal axis 12. With its contact end 13, the pressure sensor 1 sits flush on the outer side 14 of the shaping part 5. A base plate 15 bearing a contact member 16 may be arranged on the outer side 14 of the shaping part 5. The contact member 16 contacts the pressure sensor 1 and permits transmission of a sensor signal from the pressure sensor 1 to a cable 26. The cable 26 transmits the sensor signal to an evaluation element 27 as shown in FIG. 11. Evaluation element 27 uses the sensor signal to detect the pressure at the measurement end 7 of the pressure sensor 1 with a sampling rate of typically between 10 kHz and 30 kHz. As a result, the pressure at the measurement end 7 of the pressure sensor 1 may be monitored by the evaluation element 27 as a smooth curve, for example while a medium is being filled into an injection mold 25. The evaluation element 27 is used for analysis or optimization or monitoring or documentation or control of a process that is carried out by means of the shaping part 5. The shaping part 5 and base plate 15 form an injection mold 25.

FIG. 2 shows an embodiment of the pressure sensor 1 comprising a thread 2 and a further form-locking element 30 which, in contrast to the previous exemplary embodiment, is arranged in the region of the contact end 13 of the pressure sensor 1. In this exemplary embodiment, the further form-locking element 30 is a hexagon, for example. This further form-locking element 30, i.e. the hexagon, is tapered as compared to the portion of the pressure sensor 1 on which the thread 2 is formed. With constant dimensions of the recess 4 which in this case is a bore a space remains for inserting a wrench, for example, for screwing the pressure sensor 1 into the recess 4. The arrangement of the other elements, in particular the thread 2 and the shaping part thread 11, is identical to the previous embodiment.

FIG. 3 shows an embodiment of the pressure sensor 1 devoid of any thread 2 as in the embodiments of FIGS. 1 and 2 and comprising a securing element 17. At the top of FIG. 3, a securing element 17 in the form of a securing ring is shown in a top view. In the lower part of FIG. 3, a dashed line indicates where the securing element 17 is positioned in the installed state, namely in a recess 18 being formed as a securing groove in the pressure sensor 1. In this exemplary embodiment, the pressure sensor 1 projects into the base plate 15 up to its contact end 13 above which is again located the contact member 16 which is in signal contact with the pressure sensor 1. However, in this case the contact member 16 is not flush with the lower side of the base plate 15. The shaping part 5 is removable and exchangeable. The base plate 15 and shaping part 5 are rigidly connected to one another during operation of the injection mold. When the shaping part 5 is removed the securing element 17 may be introduced into the recess 18, i.e. the securing groove, of the pressure sensor 1 to fasten and/or secure the pressure sensor 1 in the shaping part 5. In this embodiment, the pressure sensor 1 sits in the recess 4 practically without any play over the entire thickness of the shaping part 5. The stepped, upwardly tapering shape of the recess 4 and the correspondingly stepped, upwardly tapering shape of the pressure sensor 1 ensure that the pressure sensor 1 is secured firmly in the shaping part 5 after the securing element 17 is attached.

The embodiment shown in FIG. 4 differs from the embodiment shown in FIG. 3 in that the securing element 17 and recess 18 are replaced by a snap-fit connection 19 consisting of a bulge 20 in the pressure sensor 1 and an elastic arm 21 of the contact member 16 for engaging the bulge 20.

In FIG. 4, a contact nipple 22 is indicated for the sake of completeness which may be connected to a measuring cable 26, as shown in FIG. 11.

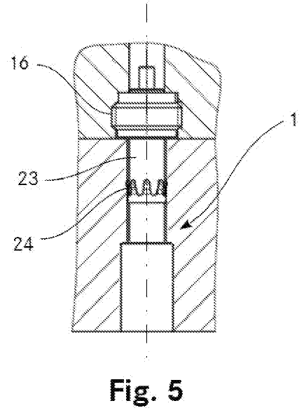

FIG. 5 shows an embodiment of the pressure sensor 1 that comprises a spacer sleeve 23. Spacer sleeve 23 transmits the measurement signal from the pressure sensor 1 to the contact member 16. Spacer sleeve 23 comprises a crown-like snap-fit or clip closure 24.

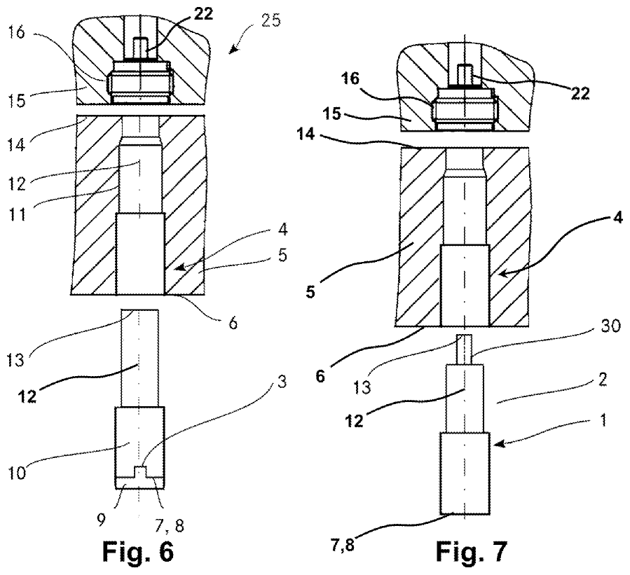

FIG. 6 shows an exploded view of the embodiment shown in FIG. 1 for illustrating the arrangement in particular of the pressure sensor 1, shaping part 5 with recess 4, base plate 15, contact member 16 with respect to each other. The pressure sensor 1, shaping part 5 and base plate 15 with the contact member 16 are shown spaced apart from each other along the longitudinal axis 12.

FIG. 7 shows an exploded view of the embodiment shown in FIG. 2 for illustrating the arrangement in particular of the pressure sensor 1, shaping part 5 with recess 4, base plate 15, contact member 16 to each other. The pressure sensor 1, shaping part 5 and base plate 15 with the contact member 16 are shown spaced apart from each other along the longitudinal axis 12.

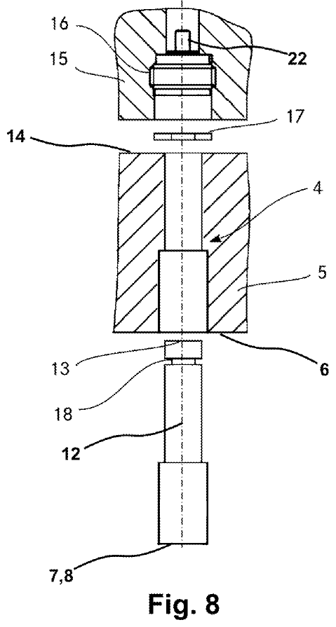

FIG. 8 shows an exploded view of the embodiment shown in FIG. 3 for illustrating the arrangement in particular of the pressure sensor 1, shaping part 5 with recess 4, securing element 17, base plate 15, contact member 16 to each other. The pressure sensor 1, shaping part 5, securing element 17 and base plate 15 with the contact member 16 are shown spaced apart from each other along the longitudinal axis 12.

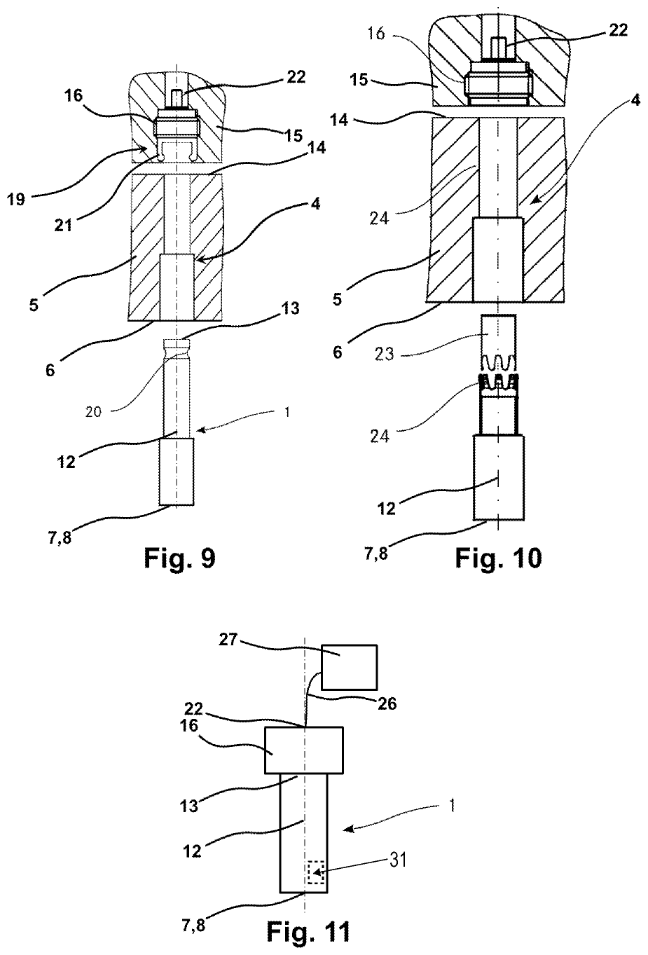

FIG. 9 shows an exploded view of the embodiment shown in FIG. 4 for illustrating the arrangement in particular of the pressure sensor 1, shaping part 5 with recess 4, base plate 15, contact member 16 to each other. The pressure sensor 1, shaping part 5 and base plate 15 with the contact member 16 are shown spaced apart from each other along the longitudinal axis 12.

FIG. 10 shows an exploded view of the embodiment shown in FIG. 5 for illustrating the arrangement in particular of the pressure sensor 1, spacer sleeve 23, shaping part 5 with recess 4, base plate 15, contact member 16 relative to each other. The pressure sensor 1, spacer sleeve, shaping part 5, and base plate 15 with the contact member 16 are shown spaced apart from each other along the longitudinal axis 12.

FIG. 11 shows a schematic representation of an assembly of a pressure sensor 1 connected to an evaluation element 27 and including a temperature sensor 31 integrated into the pressure sensor 1 and schematically represented by the square in dashed outline. The pressure sensor 1 is in contact with the contact member 16. Contact member 16 is connected to a cable 26 by which the pressure sensor signal can be transmitted to the evaluation unit 27.

In summary, it should be noted that there are a plurality of possible combinations of the features explained above of the pressure sensor according to the invention.

### LIST OF REFERENCE NUMERALS

1 pressure sensor

2 Thread

3 form-locking element

4 Recess

5 shaping part/mold insert

6 pressure measurement side

7 measurement end

8 sensor front face

9 Cover

10 pressure transducer

11 shaping part thread

12 longitudinal axis

13 contact end

14 outer side

15 base plate

16 contact element

17 securing element

18 notch

19 snap-fit connection

20 Bulge

21 elastic arm

22 contact nipple

23 spacer sleeve

24 clip closure

25 injection mold

26 Cable

27 evaluation element

28 further form-locking element

1. A pressure sensor adapted for being installed in a shaping part and electrically connected to a contact member that is external to the shaping part, the pressure sensor comprising:
a measurement end where the pressure to be measured is detected;
a contact end connected to the measurement end and configured for connection to the contact member, wherein the measurement end is aligned with the contact end along a longitudinal axis, wherein a dimension along the longitudinal axis as measured perpendicular to the longitudinal axis at the measurement end is greater than or equal to all other dimensions of the pressure sensor between the measurement end and the contact end measured perpendicular to the longitudinal axis and
a contact configured for contacting the contact member, wherein the contact is connected to the contact end and aligned along the longitudinal axis.

2. The pressure sensor according to claim 1, wherein the pressure sensor is adapted for being installed in an injection mold (25) from an injection mold cavity side.

3. The pressure sensor according to claim 1 further comprising a mold insert in which the pressure sensor is arranged in a cableless manner.

4. The pressure sensor according to claim 1, further comprising a securing means.

5. The pressure sensor according to claim 1, further comprising a thread.

6. The pressure sensor according to claim 1, further comprising a snap-fit member configured to form a snap-fit connection with a respective counterpart.

7. The pressure sensor according to claim 1, wherein the pressure sensor defines a recess configured for receiving a securing element.

8. The pressure sensor according to claim 1, further comprising an integrated temperature sensor.

9. An injection mold configured for connection to a contact member, the injection mold comprising:
a base plate configured for connection to the contact member;
a shaping part defining a pressure measurement side and an outer side disposed spaced apart in a first direction along a longitudinal axis, the shaping part further defining a recess extending from the pressure measurement side toward the outer side along the longitudinal axis;
a pressure sensor including a measurement end where the pressure to be measured is detected, a contact end connected to the measurement end and configured for connection to the contact member, wherein the measurement end is aligned with the contact end along the longitudinal axis, wherein a dimension along the longitudinal axis as measured perpendicular to the longitudinal axis at the measurement end is greater than or equal to all other dimensions of the pressure sensor between the measurement end and the contact end measured perpendicular to the longitudinal axis, and a contact connected to the contact end and aligned along the longitudinal axis and configured for contacting the contact member, wherein the contact is connected to the pressure sensor.

10. The injection mold (25) according to claim 9 further comprising a contact member connected to the contact.

11. A method for installing a pressure sensor in a shaping part defining a pressure measurement side, the method comprising the steps of:
a) creating a recess in the shaping part from the pressure measurement side,
b) inserting the pressure sensor in the recess in the shaping part from the pressure measurement side of the shaping part, and
c) securing the pressure sensor in the shaping part or in a base plate which can be connected to the shaping part.

12. The method according to claim 11, wherein the shaping part is an injection mold or a part thereof, and the pressure measurement side of the shaping part is an inner side of the injection mold.

13. The method according to claim 11, wherein the recess is a bore or at least partially comprises a bore.

14. The method according to claim 11, wherein the securing step is selected from: screwing in, snapping in, and inserting a securing element.
